(19) United States
(12) Patent Application Publication
(10) Pub. No.: US 2021/0009185 A1
(43) Pub. Date: Jan. 14, 2021

(54) STEERING WHEEL COVER

(71) Applicant: Daniel Lemyre, Kalama, WA (US)

(72) Inventor: Daniel Lemyre, Kalama, WA (US)

(21) Appl. No.: 16/505,221

(22) Filed: Jul. 8, 2019

(51) Int. Cl. B62D 1/06

(52) U.S. Cl. CPC B62D 1/06

(57) ABSTRACT

An exemplary steering wheel cover is presented. The steering wheel cover is useful for providing a mental diversion for a driver when waiting in traffic or waiting to pick someone up at a hotel, store, airport, etc. The steering wheel cover is round. The steering wheel cover may be any size but should fit tightly around a steering wheel. The steering wheel cover is preferably made of a vinyl material but other materials are hereby contemplated including, but not limited to, plastic, rubber, etc. The steering wheel cover has one or more sensor/pad combinations that have a predetermined sound associated with each of them, such as a snare drum, tom drum, cymbal, etc. When any of the pad/sensor combinations is actuated the predetermined sound is heard over the speaker system.

### FIELD OF THE INVENTION

This invention relates to steering wheels for vehicles. More particularly, it relates to covers for steering wheels.

### BACKGROUND

A steering wheel (also called a driving wheel or a hand wheel) is a type of steering control in vehicles and vessels (ships and boats).

Steering wheels are used in most modern land vehicles, including all mass-production automobiles, as well as buses, light and heavy trucks, and tractors. The steering wheel is the part of the steering system that is manipulated by the driver; the rest of the steering system responds to such driver inputs. This can be through direct mechanical contact as in recirculating ball or rack and pinion steering gears, without or with the assistance of hydraulic power steering, HPS, or as in some modern production cars with the assistance of computer-controlled motors, known as Electric Power Steering.

Steering wheels for passenger automobiles are generally circular, and are mounted to the steering column by a hub connected to the outer ring of the steering wheel by one or more spokes (single spoke wheels being a rather rare exception). Other types of vehicles may use the circular design, a butterfly shape, or some other shape. In countries where cars must drive on the left side of the road, the steering wheel is typically on the right side of the car (right-hand drive or RHD); the converse applies in countries where cars drive on the right side of the road (left-hand drive or LHD).

In addition to its use in steering, the steering wheel is the usual location for a button to activate the car's horn. Modern automobiles may have other controls, such as cruise control, audio system and telephone controls, as well as paddle shifters, built into the steering wheel to minimize the extent to which the driver must take their hands off the wheel.

The steering wheels were rigid and mounted on non-collapsible steering columns. This arrangement increased the risk of impaling the driver in case of a severe crash. The first collapsible steering column was invented in 1934 but was never successfully marketed. By 1956, Ford came out with a safety steering wheel that was set high above the post with spokes that would flex, but the column was still rigid. In 1968, United States regulations (FMVSS Standard No. 204) were implemented concerning the acceptable rearward movement of the steering wheel in case of crash. Collapsible steering columns were required to meet that standard.

Power steering gives the driver an easier means by which the steering of a car can be accomplished. Modern power steering has almost universally relied on a hydraulic system, although electrical systems are steadily replacing this technology. Mechanical power steering systems (e.g., Studebaker, 1952) have been invented, but their weight and complexity negate the benefits that they provide.

While other methods of steering passenger cars have resulted from experiments, for example the “wrist-twist” steering of the 1965 Mercury Park Lane concept car was controlled by two 5-inch (127 mm) rings, none have yet been deployed as successfully as the conventional large steering wheel.

Passenger automobile regulations implemented by the U.S. Department of Transportation required the locking of steering wheel rotation (or transmission locked in “park”) to hinder motor vehicle theft; in most vehicles, this is accomplished when the ignition key is removed from the ignition lock.

Steering wheels often have covering to help aid in the grip of the steering wheel or to show a particular like of the driver. There is no steering wheel cover that promotes interaction with a driver and may also produce sounds. There is a need for a interactive steering wheel that can produce sound based on the particular areas touched by the driver.

### BRIEF DESCRIPTION OF THE DRAWINGS

FIG. 1 is an illustrated view of an exemplary steering wheel cover.

### DETAILED DESCRIPTION

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise. Such terms do not generally signify a closed list.

“Above,” “adhesive,” “affixing,” “any,” “around,” “both,” “bottom,” “by,” “comprising,” “consistent,” “customized,” “enclosing,” “friction,” “in,” “labeled,” “lower,” “magnetic,” “marked,” “new,” “nominal,” “not,” “of,” “other,” “outside,” “outwardly,” “particular,” “permanently,” “preventing,” “raised,” “respectively,” “reversibly,” “round,” “square,” “substantial,” “supporting,” “surrounded,” “surrounding,” “threaded,” “to,” “top,” “using,” “wherein,” “with,” or other such descriptors herein are used in their normal yes-or-no sense, not as terms of degree, unless context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

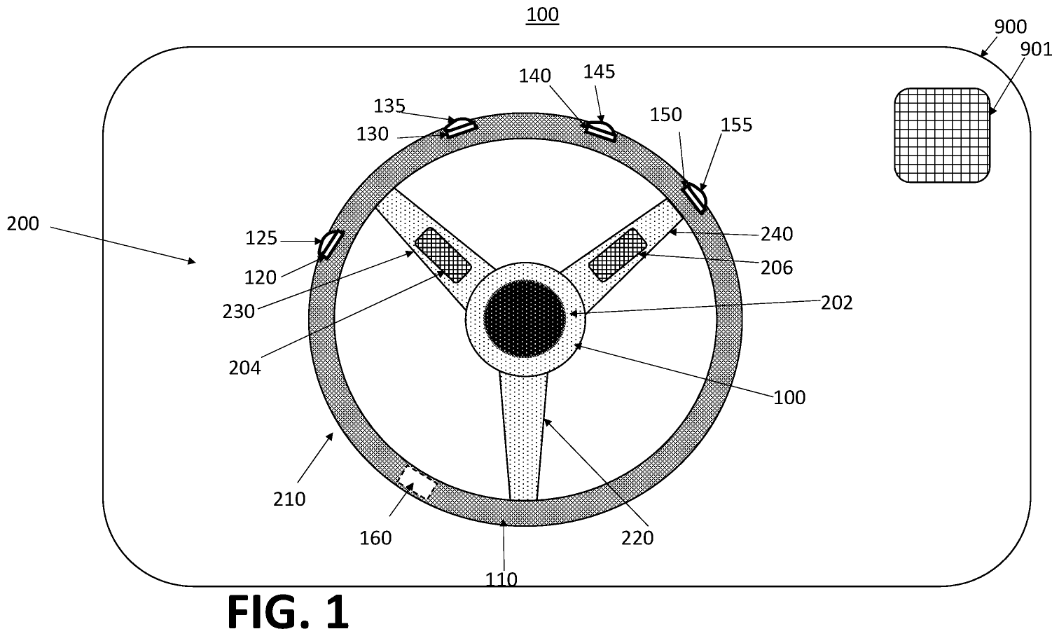

Referring to FIG. 1, an illustrated view of an exemplary steering wheel cover 100 is presented. The steering wheel cover 100 is useful for providing a mental diversion for a driver when waiting in traffic or waiting to pick someone up at a hotel, store, airport, etc.

The steering wheel cover 100 is round. The steering wheel cover 100 may be any size but should fit tightly around a steering wheel 200. The steering wheel cover 100 is preferably made of a vinyl material but other materials are hereby contemplated including, but not limited to, plastic, rubber, etc.

The steering wheel 200 has a handle area 210, a center portion 220, a first arm 230, a second arm 240 and a third arm 250. The steering wheel 200 is useful for directing a vehicle and providing access to a horn control 202, speed controls 204 and electronics control 206.

The steering wheel cover 100 is securely coupled to the handle area 210 of the steering wheel 200. The steering wheel cover 100 is specifically designed to fit tightly to the steering wheel 200 such that the steering wheel cover 100 does not move when in use.

The steering wheel cover 100 has a grip area 110, a first sensor 120, a first pad 125, a second sensor 130, a second pad 135, a third sensor 140, a third pad 145, a fourth sensor 150, a fourth pad 155 and a power source 160. There are four sensors/pad combinations for example only, there could be any number of sensor/pad combinations. There are one or more predetermined sounds.

The first pad 125 is securely and communicatively coupled to the first sensor 120 of the steering wheel cover 100. Thus, when the first pad 125 is actuated, the first sensor 120 is activated. The first sensor 120 has a first predetermined sound which is communicatively coupled to a speaker (not shown) of the vehicle. The first predetermined sound is preferably a hi-hat drum sound, but other pre-determined sounds are hereby contemplated including, but not limited to, a snare drum sound, a guitar sound, a tom drum sound, a cymbal sound, etc.

The second pad 135 is securely and communicatively coupled to the second sensor 130 of the steering wheel cover 100. Thus, when the second pad 135 is actuated, the second sensor 130 is activated. The second sensor 130 has a second predetermined sound which is communicatively coupled to a speaker (not shown) of the vehicle. The second predetermined sound is preferably a cymbal sound, but other pre-determined sounds are hereby contemplated including, but not limited to, a snare drum sound, a guitar sound, a tom drum sound, a hi-hat drum sound, etc.

The third pad 145 is securely and communicatively coupled to the third sensor 140 of the steering wheel cover 100. Thus, when the third pad 145 is actuated, the third sensor 140 is activated. The third sensor 140 has a third pre-determined sound which is communicatively coupled to a speaker of the vehicle. The second predetermined sound is preferably a cymbal sound, but other pre-determined sounds are hereby contemplated including, but not limited to, a tom drum sound, a guitar sound, a snare sound, a hi-hat drum sound, etc.

The fourth pad 155 is securely and communicatively coupled to the fourth sensor 150 of the steering wheel cover 100. Thus, when the fourth pad 155 is actuated, the fourth sensor 150 is activated. The fourth sensor 150 has a fourth predetermined sound which is communicatively coupled to the speaker of the vehicle. The second predetermined sound is preferably a snare sound, but other pre-determined sounds are hereby contemplated including, but not limited to, a tom drum sound, a guitar sound, a cymbal sound, a hi-hat drum sound, etc.

The power source 160 is coupled to a back side (not shown) of the steering wheel cover 100. The power source 160 is preferably a battery, but other power sources are contemplated including, but not limited to, be a rechargeable battery, a NiCad battery, etc.

The power source 160 is securely and communicatively coupled to the first sensor pad 120 of the steering wheel cover 100, the second sensor pad 130 of the steering wheel cover 100, the third sensor pad 140 of the steering wheel cover 100 and the fourth sensor pad 150 of the steering wheel cover 100.

In the numbered clauses below, specific combinations of aspects and embodiments are articulated in a shorthand form such that (1) according to respective embodiments, for each instance in which a “component” or other such identifiers appear to be introduced (with “a” or “an,” e.g.) more than once in a given chain of clauses, such designations may either identify the same entity or distinct entities; and (2) what might be called “dependent” clauses below may or may not incorporate, in respective embodiments, the features of “independent” clauses to which they refer or other features described above.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

The features described with respect to one embodiment may be applied to other embodiments or combined with or interchanged with the features of other embodiments, as appropriate, without departing from the scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. A steering wheel cover for providing a mental diversion for a parked driver, the steering wheel cover consisting of:
a plurality of sensors;
a plurality of pads, each of the plurality of pads being coupled to each of the plurality of sensors;
each of the plurality of sensors being coupled to a speaker in a vehicle;
the plurality of pads and the plurality of sensors being coupled to the steering wheel cover, wherein the steering wheel cover being made of a rubber material; and
predetermined sounds, wherein a first of the predetermined sounds being a guitar sound, and wherein when one of the plurality of pads is actuated, the coupled one of the plurality of sensors is activated and a predetermined sound of the predetermined sounds being communicated to the speaker.

2. The steering wheel cover of claim 1, wherein a second of the predetermined sounds being a snare drum.

3. The steering wheel cover of claim 1, wherein a second of the predetermined sounds being a tom drum.

4. The steering wheel cover of claim 1, wherein a third of the predetermined sounds being a cymbal.

5. The steering wheel cover of claim 1, wherein a fourth of the predetermined sounds being a hi hat drum.

6. The steering wheel cover of claim 1, the cover further consisting of:
a power source;
the power source being coupled to a bottom of the steering wheel cover; and
the power source being communicatively coupled to each of the plurality of sensors.

7. The steering wheel cover of claim 6, wherein the power source is a battery.

8. The steering wheel cover of claim 1, wherein the steering wheel cover being round.

9. (canceled)

10. (canceled)

11. A steering wheel cover for providing a mental diversion for a parked driver, the steering wheel cover comprising:
a plurality of sensors;
a plurality of pads, each of the plurality of pads being coupled to each of the plurality of sensors;
a power source, the power source being a battery, wherein the power source being coupled to a bottom of the steering wheel cover; and
the power source being communicatively coupled to each of the plurality of sensors each of the plurality of sensors being coupled to a speaker in a vehicle;
the plurality of pads/sensors coupling being coupled to the steering wheel cover, wherein the steering wheel cover being made of a rubber material; and
predetermined sounds, wherein a first of the plurality of predetermined sounds being a guitar sound, and wherein when one of the plurality of pads is actuated, the coupled one of the plurality of sensor is activated and a predetermined sound of one of the plurality of predetermined sounds being communicated to the speaker, and wherein the steering wheel cover being round.
